(19) United States
(12) Patent Application Publication
(10) Pub. No.: US 2026/0328193 A1
(43) Pub. Date: Oct. 22, 2026

(54) SENSOR ARRANGEMENT FOR RECORDING AT LEAST A FIRST DEFORMATION OF A ROTOR BLADE OF A WIND TURBINE

(71) Applicant: DR. JOHANNES HEIDENHAIN GmbH, Traunreut (DE)

(72) Inventors: Markus Meißner, Übersee (DE); Robert Kraus, Trostberg (DE); Michael Hafner, St. Georgen (DE)

(21) Appl. No.: 19/649,156

(22) Filed: Apr. 16, 2026

(30) Foreign Application Priority Data
Apr. 17, 2025 (DE) 10 2025 001 277.2

(51) Int. Cl. F03D 17/00

(52) U.S. Cl. CPC F03D 17/014; F03D 17/011; F05B 2270/107; F05B 2270/80

(57) ABSTRACT

A sensor arrangement for recording deformation of a rotor blade, including a transmission unit and a first transceiver unit arranged along a bending line of the rotor blade. The sensor arrangement is configured to generate a first to third light. The first light is generated as a first light pulse having a first pulse duration. The second light is generated as a second light pulse having a second pulse duration. The first transceiver unit is configured such that the third light is generated as a third light pulse having a third pulse duration. The sensor arrangement is configured such that the first to third light pulses are generated as part of a sequence and configured to set the first to third pulse durations at random and/or to select a distribution of the first to third light pulses within the sequence at random.

### CROSS REFERENCE TO RELATED APPLICATIONS

This application claims benefit to German Patent Application No. DE 10 2025 001 277.2, filed on Apr. 17, 2025, which is hereby incorporated by reference herein.

### FIELD

The present invention relates to a sensor arrangement for recording at least a first deformation of a rotor blade of a wind turbine.

### BACKGROUND

WO 2021/064243 A1 discloses a system for tracking the movement of a rotor blade of a wind turbine. The system for tracking the blade movement is installed on the rotor blade, for example. The rotor blade comprises a blade root and a blade tip. The system comprises at least one light module, which comprises at least one first light source, which is preferably used to emit light toward the blade root. An optical measurement device is provided, which is preferably arranged at the blade root in order to receive the light emitted by the one or more first light sources. The optical measurement apparatus is preferably a position-sensitive detector (PSD) for detecting the position of the first light source relative to the position-sensitive detector. A single light source arranged at the blade tip, close to the blade tip, or in the direction of the blade tip is sufficient for measuring flexion of the rotor blade. Advantageously, the first light source is modulated at a predefined modulation frequency so that the light of the first light source can be distinguished from ambient light. This minimizes the influence of ambient light conditions during recording.

DE 43 30 223 A1 discloses a method and a device for increasing interference suppression, in particular in optical proximity switches, by means of an optical transmitter that sends out an optical pulse sequence, by means of an optical receiver that sends out a measurement signal, and by means of a control and evaluation unit that controls the optical transmitter and evaluates the measurement signal.

### SUMMARY

In an embodiment, the present disclosure provides a sensor arrangement for recording at least a first deformation of a rotor blade of a wind turbine, comprising a transmission unit arranged at a first position and at least one first transceiver unit arranged along a bending line of the rotor blade at a second position. The sensor arrangement is configured to generate a first light, a second light, and a third light. The transmission unit is configured such that the first light is generated as a first light pulse having a first pulse duration. The sensor arrangement is configured such that the second light is generated as a second light pulse having a second pulse duration. The at least one first transceiver unit is configured such that the third light is generated as a third light pulse having a third pulse duration. The sensor arrangement is configured such that the first light pulse, the second light pulse, and the third light pulse are generated as part of a pulse sequence. The first light pulse, the second light pulse, and the third light pulse have a distribution within the pulse sequence. The sensor arrangement is configured to set the first pulse duration, the second pulse duration, and the third pulse duration at random and/or to select the distribution at random.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a perspective view of an example rotor blade to illustrate a first and a second torsion of the rotor blade;

FIG. 2 is a perspective view of an example rotor blade comprising an example sensor arrangement having a transmission unit, a plurality of transceiver units, and a receiving unit, for forming a metrology chain;

FIG. 3 is a block diagram of the transmission unit, the transceiver units, and the receiving unit according to FIG. 2;

FIG. 4a is a block diagram of an example transmission unit according to FIG. 3;

FIG. 4b is a block diagram of an example transceiver unit of the transceiver units according to FIG. 3;

FIG. 4c is a block diagram of an example transceiver unit of the transceiver units according to FIG. 3;

FIG. 4d is a block diagram of an example receiving unit according to FIG. 3;

FIG. 5a is a block diagram of an example transmission unit according to FIG. 3;

FIG. 5b is a block diagram of an example transceiver unit of the transceiver units according to FIG. 3;

FIG. 6a shows a first example pulse schema having an example pulse sequence;

FIG. 6b shows a first example detection schema relating to the first pulse schema;

FIG. 6c shows a second example detection schema relating to the first pulse schema;

FIG. 7a shows a second example pulse schema having an example pulse sequence;

FIG. 7b shows a third example detection schema relating to the second pulse schema;

FIG. 8a shows a first example evaluation schema relating to the first detection schema;

FIG. 8b shows a second example evaluation schema relating to the second detection schema; and

FIG. 8c shows a third example evaluation schema relating to the third detection schema.

### DETAILED DESCRIPTION

In an embodiment, the present disclosure provides a sensor arrangement for recording at least a first deformation of a rotor blade of a wind turbine, said arrangement having a simple and reliable design and allowing the rotor blade to be detected in an improved manner.

The sensor arrangement formed in accordance with an embodiment of the present disclosure is used for recording at least a first deformation of a rotor blade of a wind turbine. The sensor arrangement has a transmission unit arranged at a first position and at least one first transceiver unit arranged along a bending line of the rotor blade at a second position. The sensor arrangement is configured to generate first to third light. The transmission unit is configured such that the first light is generated as a first light pulse having a first pulse duration. The sensor arrangement is configured such that the second light is generated as a second light pulse having a second pulse duration. The first transceiver unit is configured such that the third light is generated as a third light pulse having a third pulse duration. The sensor arrangement is configured such that the first light pulse, the second light pulse, and the third light pulse are generated as part of a pulse sequence. The first light pulse, the second light pulse, and the third light pulse have a distribution within the pulse sequence. The sensor arrangement is configured to set the first pulse duration, the second pulse duration, and the third pulse duration at random and/or to select the distribution at random.

Preferably, the transmission unit is configured to generate the first light. The first transceiver unit is preferably configured to generate the second and the third light.

Alternatively, the transmission unit can be configured to generate the first and the second light. Alternatively, the first transceiver unit can be configured to generate the third light.

Preferably, the sensor arrangement is configured to set each of the first pulse duration, the second pulse duration, and the third pulse duration at random but without the distribution being selected at random. A first example pulse schema having an example pulse sequence can be implemented as a result. The first example pulse schema can efficiently suppress interference caused by environmental influences (in particular ambient light).

Alternatively, the sensor arrangement can be configured to set each of the first pulse duration, the second pulse duration, and the third pulse duration at random and to select the distribution at random. A second example pulse schema having an (alternative) example pulse sequence can be implemented as a result. The second example pulse schema can further improve the suppression of interference (in particular ambient light).

It is advantageous for the distribution to include an order, the order being defined by a permutation of the generation of the first light pulse, the second light pulse, and the third light pulse.

It is advantageous for the sensor arrangement to be configured such that the first light pulse, the second light pulse, and the third light pulse are generated as part of a first group of light pulses, the pulse sequence comprising the first group of light pulses, and for the sensor arrangement to be configured to set all the pulse durations of the first group of light pulses and all the durations of pulse breaks (also referred to as interpulse intervals) within a first portion of the pulse sequence at random in each case such as to obtain a randomly set total duration made up of the pulse durations of the first group of light pulses and the durations of pulse breaks.

Preferably, a duration of the first portion of the pulse sequence is defined by the total duration made up of the pulse durations of the first group of light pulses and the durations of pulse breaks.

A pulse sequence portion defined by a group of light pulses can also be referred to as a burst. Preferably, therefore, a burst has a randomly set duration (burst duration).

Alternatively, it is advantageous for a duration of the first portion of the pulse sequence to be fixedly predetermined by the sensor arrangement, the sensor arrangement being configured to adapt either a pulse duration of a final light pulse of the first group of light pulses or a duration of a final pulse break within the first portion of the pulse sequence in such a way that the total duration made up of the pulse durations of the first group of light pulses and the durations of pulse breaks is equal to the duration of the fixedly predetermined first portion of the pulse sequence.

Thus, a burst can alternatively also have a fixedly predetermined duration (burst duration).

Preferably, the sensor arrangement is configured to record at least a first torsion of the rotor blade on the basis of a polarization rotation of the first light. Thus, the sensor arrangement in particular implements a torsion measurement within a metrology chain.

Embodiments of the present disclosure allow at least a first deformation (e.g., flexion and/or torsion) to be detected in an improved manner using a sensor arrangement that has a simple and reliable design. During detection, interference caused by environmental influences (e.g., ambient light, light from other measurement systems, electrical interference from a generator, etc.) can be efficiently suppressed. The interference is suppressed especially efficiently in particular when it is close to or substantially at a (fixed) frequency of the generation or modulation of the light pulses within a pulse sequence in a reference pulse schema. Superimposition of the interference and pulse sequence on each other, or the coupling-in of the interference during detection, can be done in particular either optically or electronically. Embodiments of the present disclosure thus allow for improved detection in the event that interference as mentioned above is present.

Further details and advantages of the present disclosure will be explained on the basis of the following description of embodiment examples in conjunction with the drawings.

Identical or functionally identical elements are provided with the same reference numerals in the figures.

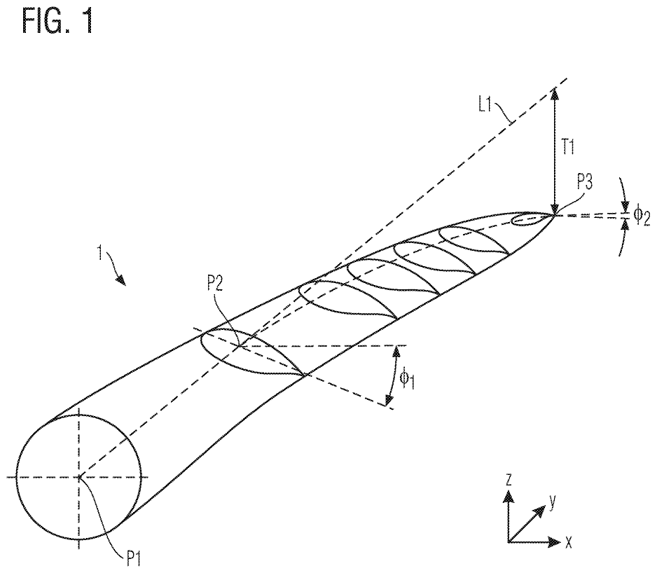

FIG. 1 is a perspective view of an example rotor blade 1 to illustrate a first and a second torsion φ₁, φ₂ of the rotor blade 1. The rotor blade 1 has a longitudinal axis L1. The first torsion φ₁ is defined in relation to a first position P1 and a second position P2. The second torsion φ₂ is defined in relation to the second position P2 and a third position P3. The first to third positions P1 to P3 are arranged along a longitudinal extent of the rotor blade 1, each at a distance from one another.

As shown in FIG. 1 the rotor blade 1 has a predetermined bend T1 (prebend). The predetermined bend T1 is defined in relation to the longitudinal axis L1. By way of example, the predetermined bend T1 extends in the negative Z direction (cf. FIG. 1).

A first direction (X direction) or a coordinate axis X is perpendicular to the longitudinal axis L1. A second direction (Z direction) or a coordinate axis Z is defined by the predetermined bend T1 of the rotor blade 1. A third direction (Y direction) or a coordinate axis Y is parallel to the longitudinal axis L1. The coordinate system shown in FIG. 1 is formed by the first to third directions (coordinate axis X, Z, Y).

By way of example, the first position P1 corresponds to a position at or close to a blade root of the rotor blade 1. By way of example, the third position P3 corresponds to a position at or close to a blade root of the rotor blade 1. By way of example, the second position P2 corresponds to a position within the rotor blade 1. By way of example, the second position P2 is arranged between the first and the third position P1, P3.

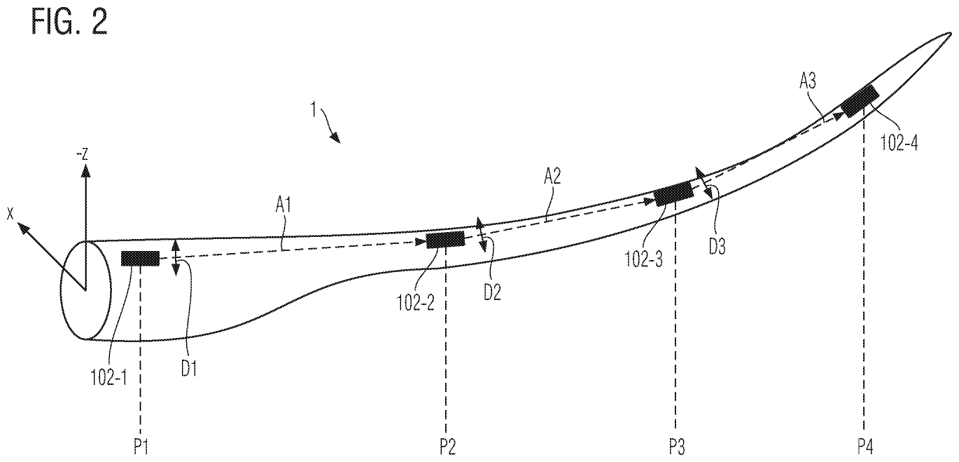

An example sensor arrangement will now be explained below on the basis of FIGS. 2 and 3, FIGS. 4a to 4d, and FIGS. 5a and 5b. The example sensor arrangement is used for recording at least a first deformation (here torsion φ₁; cf. FIG. 1).

FIGS. 2 and 3, FIGS. 4a to 4d, and FIGS. 5a and 5b show in particular details of a metrology chain. As can be seen in FIG. 2, the metrology chain is provided in an arcuate rotor blade 1.

FIG. 2 shows four different positions P1 to P4. The first position P1 in FIG. 2 corresponds in particular to the first position P1 in FIG. 1. The second to fourth positions P2 to P4 in FIG. 2 correspond to a plurality of positions arranged along a longitudinal extent of the rotor blade 1. The first and second positions P1, P2 are arranged at a first distance (first line of sight A1) from one another. The second and third positions P2, P3 are arranged at a second distance (second line of sight A2) from one another. The third and fourth positions P3, P4 are arranged at a third distance (third line of sight A3) from one another. The first to third lines of sight A1 to A3 form a curve. This curve substantially corresponds to a bending line of the rotor blade 1. As shown by way of example in FIG. 2, the rotor blade 1 is curved in the negative Z direction.

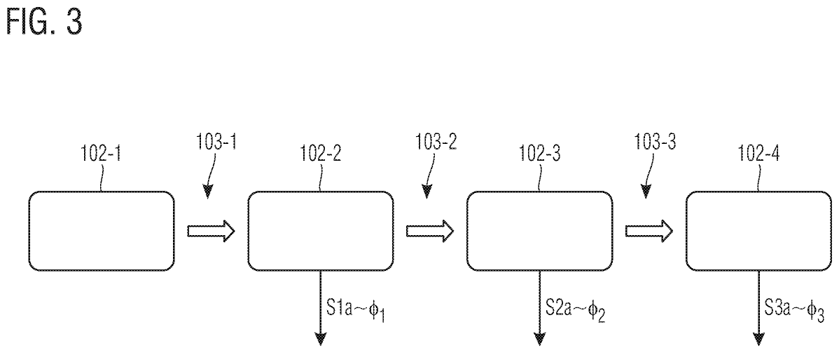

The example sensor arrangement (cf. FIG. 2) has a transmission unit 102-1 arranged at the first position P1, a plurality of transceiver units arranged along the bending line of the rotor blade 1 at the second and third positions P2, P3 (i.e., the first and the second transceiver unit 102-2, 102-3), and a receiving unit 102-4 arranged at the fourth position P4. The metrology chain formed by the transmission unit 102-1, the first and the second transceiver unit 102-2, 102-3, and the receiving unit 102-4 is shown schematically in FIG. 3.

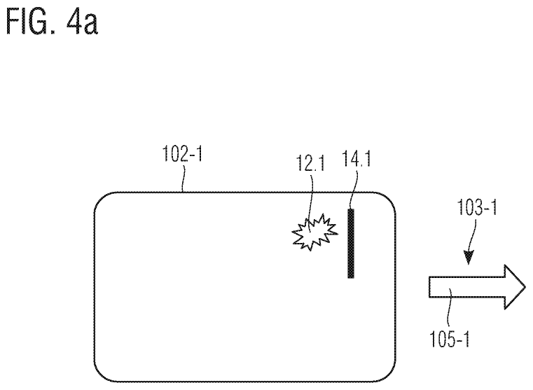

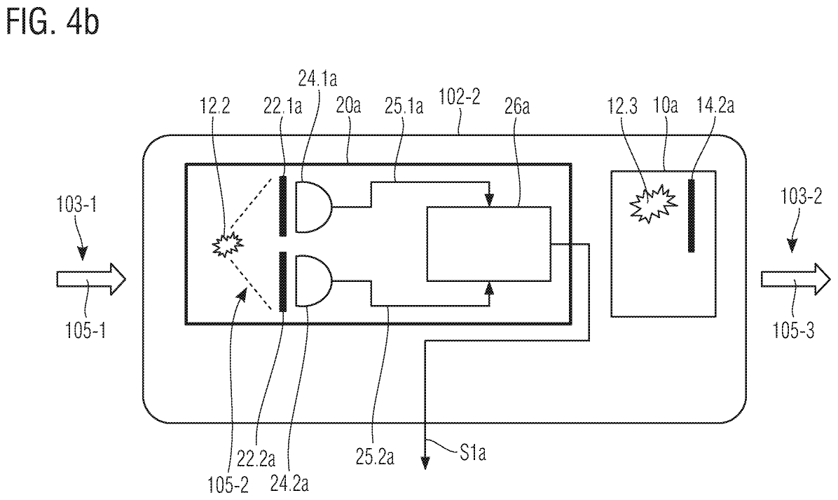

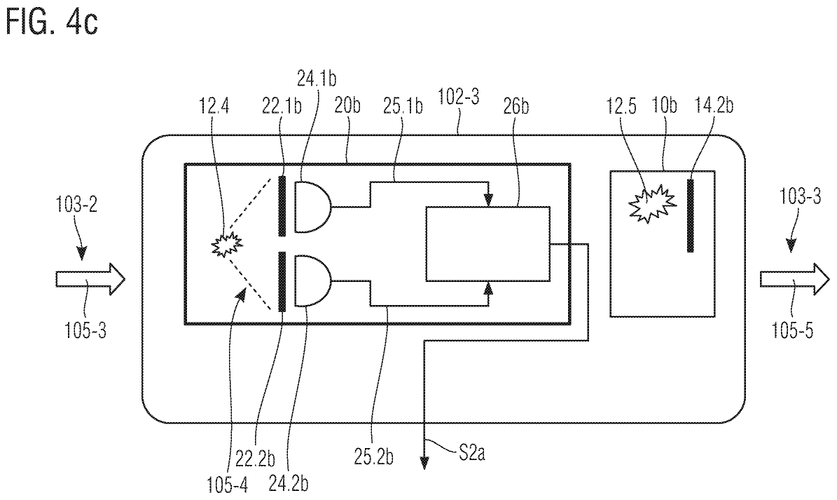

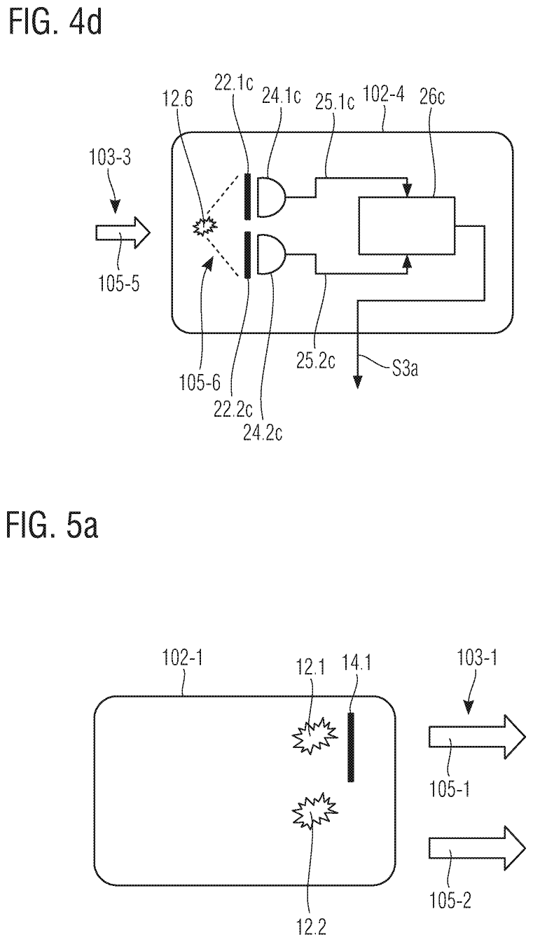

With reference to FIG. 4a, the transmission unit 102-1 comprises a first light source 12.1 for generating light, and a first transmit-side polarizer 14.1, arranged downstream of the first light source 12.1 in the light propagation direction, for generating linearly polarized light as first light 105-1.

With reference to FIG. 4b, the first transceiver unit 102-2 comprises a first detector element 24.1a and a second detector element 24.2a. The first detector element 24.1a and the second detector element 24.2a are arranged and formed such that they receive at least the first light 105-1. The first and the second detector element 24.1a, 24.2a are arranged next to one another in a plane (i.e., the X-Z plane).

The first transceiver unit 102-2 according to FIG. 4b comprises a first receive-side polarizer 22.1a, arranged upstream of the first detector element 24.1a in the light propagation direction, and a second receive-side polarizer 22.2a, arranged upstream of the second detector element 24.2a in the light propagation direction. An orientation of a polarization plane of the first receive-side polarizer 22.1a and an orientation of a polarization plane of the second receive-side polarizer 22.2a are different from each other.

The first transmit-side polarizer 14.1 and the first and the second receive-side polarizer 22.1a, 22.2a can also be referred to as linear polarizers. Preferably, the orientation of the polarization plane of the first receive-side polarizer 22.1a and the orientation of the polarization plane of the second receive-side polarizer 22.2a are substantially perpendicular to one another (i.e., at an angle of around 90°).

The first transceiver unit 102-2 according to FIG. 4b has a second light source 12.2 for generating unpolarized light as second light 105-2. As shown in FIG. 4b, the first detector element 24.1a and the second detector element 24.2a are arranged and formed such that they receive the second light 105-2. The first and the second detector element 24.1a, 24.2a are used both for receiving the first light 105-1 in the form of linearly polarized light and for receiving the second light 105-2 in the form of unpolarized light.

With reference to FIG. 4b, the first transceiver unit 102-2 has an evaluation unit 26a for generating an output signal Sla, which constitutes or comprises a measure of the first torsion φ₁, depending on a first measurement signal 25.1a generated by the first detector element 24.1a and depending on a second measurement signal 25.2a generated by the second detector element 24.2a.

By way of example, the evaluation unit 26a calculates a ratio between the difference and the sum of the first and the second measurement signal 25.1a, 25.2a.

As can be seen in FIG. 4b, the first transceiver unit 102-2 comprises a third light source 12.3 for generating third light 105-3 and a second transmit-side polarizer 14.2a arranged downstream of the third light source 12.3 in the light propagation direction. The third light source 12.3 and the second transmit-side polarizer 14.2a are configured to generate linearly polarized light as third light 105-3.

The first and the second detector element 24.1a, 24.2a, the first and the second receive-side polarizer 22.1a, 22.2a, and the evaluation unit 26a form a receiving unit 20a. The third light source 12.3 and the second transmit-side polarizer 14.2a form a transmission unit 10a.

The second transceiver unit 102-3 according to FIG. 4c is formed similarly to the first transceiver unit 102-2 according to FIG. 4b. The second transceiver unit 102-3 comprises the units 20b and 10b, which correspond to the units 20a and 10a in FIG. 4b, respectively. The unit 20b in turn comprises the elements 24.1b, 24.2b, 22.1b, 22.2b, 26b, which correspond to the elements 24.1a, 24.2a, 22.1a, 22.2a, 26a in FIG. 4b, respectively. The unit 10b in turn comprises the element 14.2b, which corresponds to the element 14.2a in FIG. 4b.

The receiving unit 102-4 according to FIG. 4d is formed similarly to the unit 20a or 20b in FIGS. 4b and 4c, respectively. The unit 102-4 comprises the elements 24.1c, 24.2c, 22.1c, 22.2c, 26c, which correspond to the elements 24.1a, 24.2a, 22.1a, 22.2a, 26a in FIG. 4b or the elements 24.1b, 24.2b, 22.1b, 22.2b, 26b in FIG. 4c, respectively.

With reference to FIG. 4c, the second transceiver unit 102-3 according to FIG. 4c has a fourth light source 12.4 for generating fourth light 105-4 (i.e., unpolarized light). Furthermore, the second transceiver unit 102-3 comprises a fifth light source 12.5 for generating fifth light 105-5 (i.e., linearly polarized light). With reference to FIG. 4d, the receiving unit 102-4 according to FIG. 4d has a sixth light source 12.6 for generating sixth light 105-6 (i.e., unpolarized light).

Thus, the example sensor arrangement is used for generating first to sixth light 105-1 to 105-6 (cf. FIGS. 4a to 4d).

The first transceiver unit 102-2 is used for generating the output signal Sla, which constitutes the measure of the first torsion φ₁ (cf. FIG. 4b). The second transceiver unit 102-3 is used for generating an output signal S2a, which constitutes a measure of a second torsion φ₂ (cf. FIG. 4c). The receiving unit 102-4 is used for generating an output signal S3a, which constitutes a measure of a third torsion φ₃ (cf. FIG. 4d).

With reference to FIG. 3, the transmission unit 102-1, the first and the second transceiver unit 102-2, 102-3, and the receiving unit 102-4 can also be referred to as metrology blocks. As shown schematically in FIG. 3 (in conjunction with FIGS. 4a and 4b), the first light 105-1 is transmitted (here shown as an arrow with reference numeral 103-1) between the metrology blocks 102-1, 102-2. FIG. 3 (in conjunction with FIGS. 4b and 4c) also schematically shows that the third light 105-3 is transmitted (here shown as an arrow with reference numeral 103-2) between the metrology blocks 102-2, 102-3. FIG. 3 (in conjunction with FIGS. 4c and 4d) furthermore schematically shows that the fifth light 105-5 is transmitted (here shown as an arrow with reference numeral 103-3) between the metrology blocks 102-3, 102-4.

Using the above-described metrology chain, a measurement of deformation or torsion over a plurality of positions arranged along the bending line of the rotor blade 1 (e.g., positions P1 to P4) is obtained.

For this deformation or torsion measurement, it is advantageous for the first light source 12.1 and the first transmit-side polarizer 14.1 to be configured to generate the linearly polarized light as first light 105-1 in such a way that a polarization direction of the linearly polarized light is either parallel or perpendicular to the second direction Z. For the first line of sight A1, this is shown in FIG. 2 by the double-headed arrow D1. The same applies to the second and third lines of sight A2, A3 in FIG. 2 (double-headed arrows D2, D3).

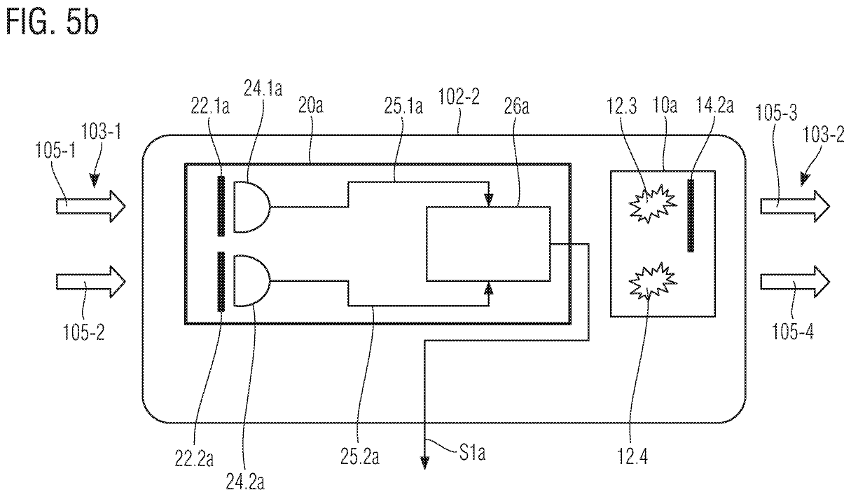

The transmission unit 102-1 according to FIG. 5a (alternative transmission unit 102-1) differs from the transmission unit 102-1 according to FIG. 4a in that it has (in addition to the first light source 12.1 for generating the first light 105-1) a second light source 12.2 for generating unpolarized light as second light 105-2.

The first transceiver unit 102-2 according to FIG. 5b (alternative first transceiver unit 102-2) differs from the first transceiver unit 102-2 according to FIG. 4b in that the unit 20a (receiving unit) of the first transceiver unit 102-2 according to FIG. 5b does not comprise the second light source 12.2. Furthermore, the first transceiver unit 102-2 according to FIG. 5b differs from the first transceiver unit 102-2 according to FIG. 4b in that the unit 10a (transmission unit) of the first transceiver unit 102-2 according to FIG. 5b has (in addition to the third light source 12.3 for generating the third light 105-3) a fourth light source 12.4 for generating unpolarized light as fourth light 105-4.

Alternatively, with reference to FIG. 3 (in conjunction with FIGS. 5a and 5b), the first and the second light 105-1, 105-2 can be transmitted (here shown as two arrows in FIGS. 5a and 5b and as one arrow in FIG. 3 with reference numeral 103-1) between the metrology blocks 102-1, 102-2.

An alternative second transceiver unit 102-3 can be formed similarly to the first transceiver unit 102-2 according to FIG. 5b. Furthermore, an alternative receiving unit 102-4 can be formed similarly to the unit 20a (receiving unit) of the first transceiver unit 102-2 according to FIG. 5b.

Thus, owing to the alternative first and second transceiver units 102-2, 102-3 (metrology blocks 102-2, 102-3), the third and the fourth light 105-3, 105-4 can be transmitted between the metrology blocks 102-2, 102-3 (cf. FIG. 3, arrow 103-2; FIG. 5b, arrows 105-3, 105-4). Furthermore, owing to the alternative second transceiver unit 102-3 and the alternative receiving unit 102-4 (metrology blocks 102-3, 102-4), the fifth and the sixth light 105-5, 105-6 can be transmitted between the metrology blocks 102-3, 102-4 (cf. FIG. 3, arrow 103-3).

For more details regarding the operation of the sensor arrangement (cf. the evaluation unit 26a to 26c according to FIGS. 4b to 4d and the evaluation unit 26a according to FIG. 5b), reference is made to application EP 4 194 802 A1, the content of which is hereby incorporated by reference in its entirety herein.

Preferably, the sensor arrangement is configured to record at least the first torsion φ₁ (or a measure of the angle φ₁ of the first torsion) of the rotor blade 1 on the basis of a polarization rotation of the first light 105-1. In this context, reference is again made to the above-mentioned application EP 4 194 802 A1.

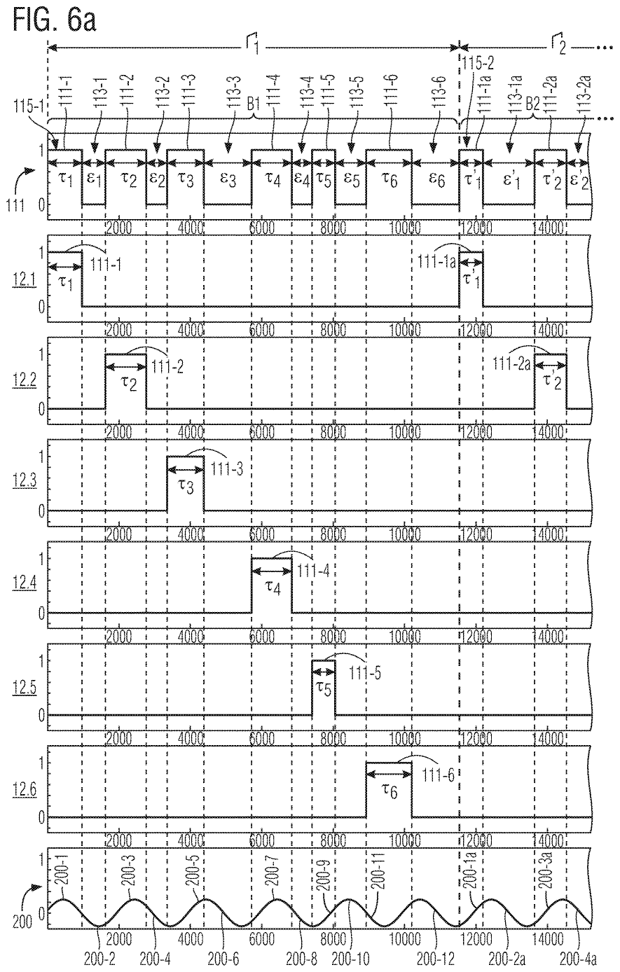

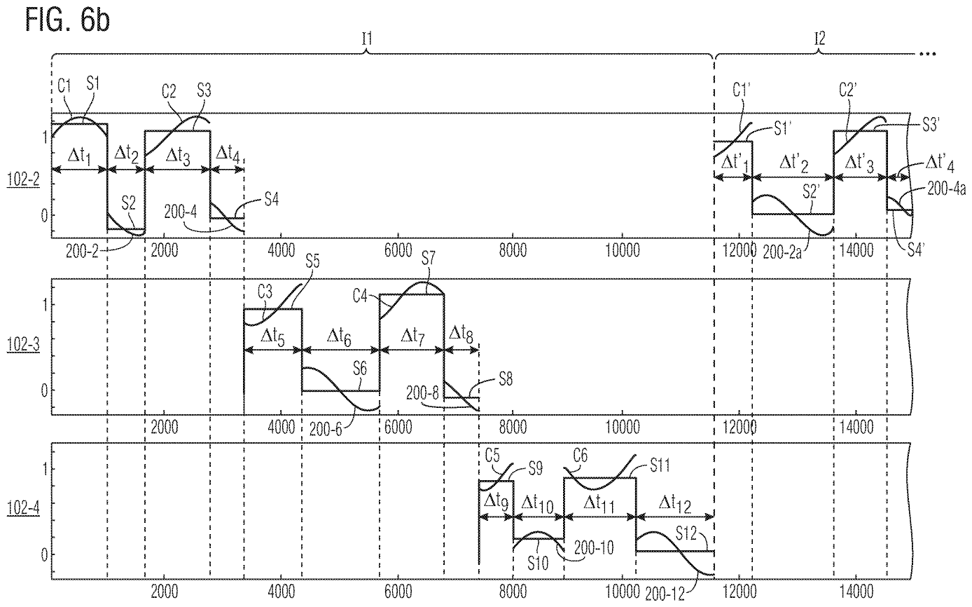

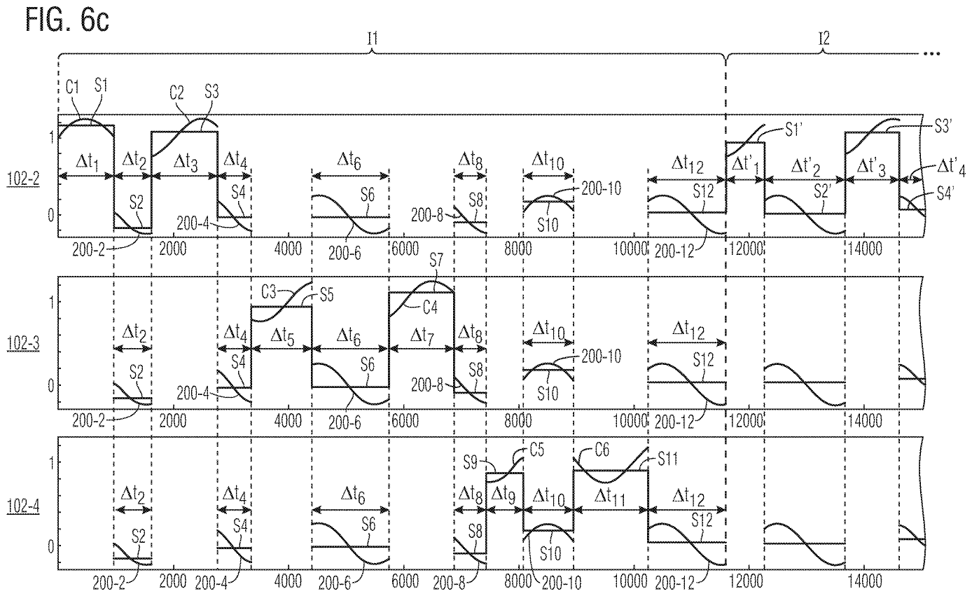

Hereinafter, reference will be made to the above-described figures (including FIG. 3) in conjunction with FIG. 6a et seq.

In the example sensor arrangement, the transmission unit 102-1 is configured such that the first light 105-1 is generated as a first light pulse 111-1 having a first pulse duration τ₁. The sensor arrangement is configured such that the second light 105-2 is generated as a second light pulse 111-2 having a second pulse duration T2. The first transceiver unit 102-2 is configured such that the third light 105-3 is generated as a third light pulse 111-3 having a third pulse duration T3.

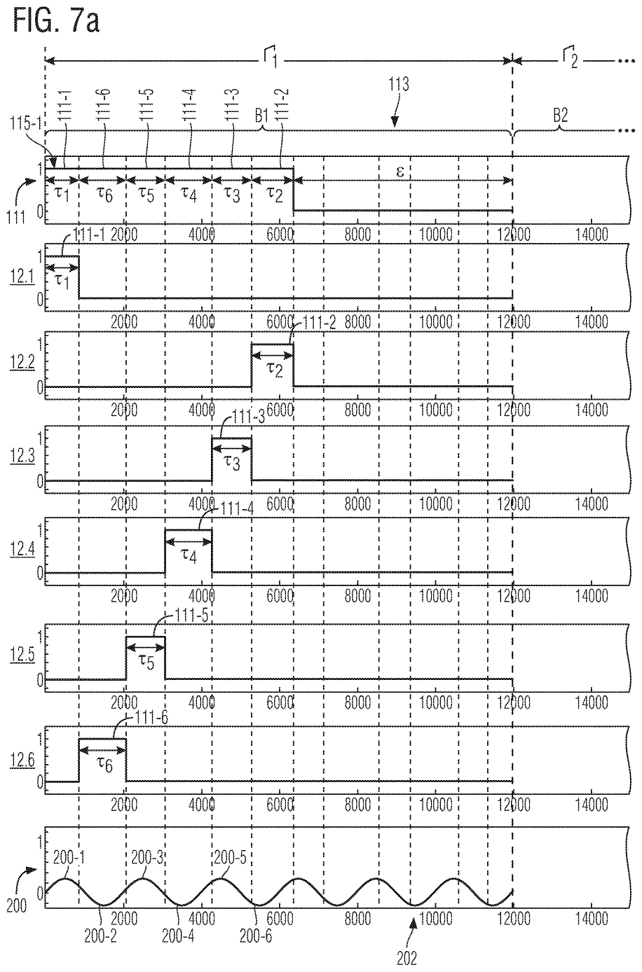

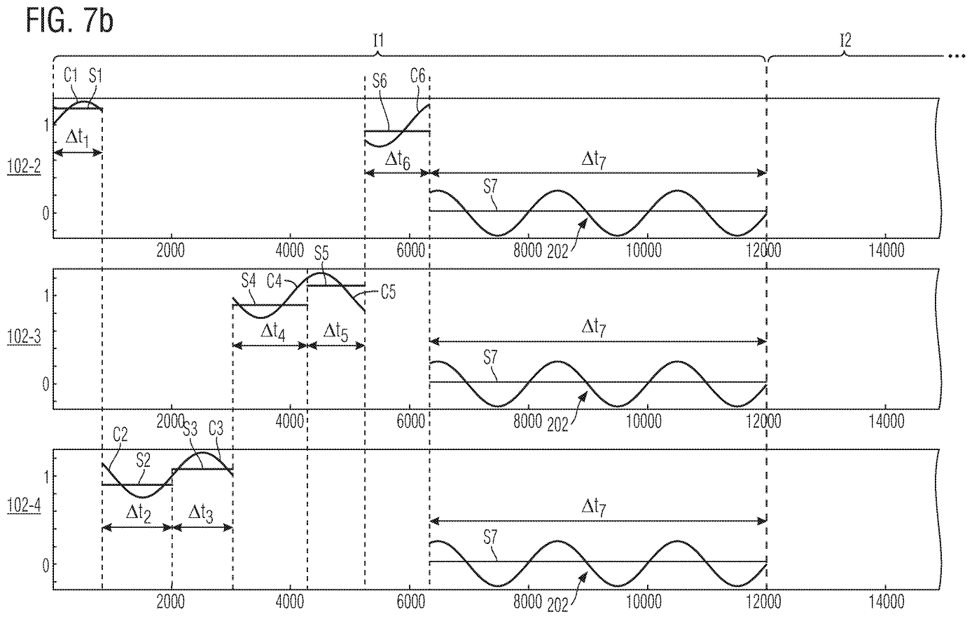

In addition, the sensor arrangement can be configured such that the fourth to sixth light 105-4 to 105-6 are generated as fourth to sixth light pulses 111-4 to 111-6 having a fourth to sixth pulse duration τ₄ to τ₆. This is shown by way of example in FIGS. 6a and 7a.

FIG. 6a shows a first example pulse schema having an example pulse sequence 111. The pulse sequence 111 comprises a first group 115-1 of light pulses. Furthermore, the pulse sequence 111 comprises at least a second (subsequent) group 115-2 of light pulses. The first group 115-1 of light pulses comprises the first to sixth light pulses 111-1 to 111-6. The second group 115-2 of light pulses comprises at least one further first light pulse 111-1a associated with the first light pulse 111-1, and a further second light pulse 111-2a associated with the second light pulse 111-2. The further first light pulse 111-1a has a further first pulse duration

$${τ}_{1}^{′} .$$

The further second light pulse 111-2a has a further second pulse duration

$${τ}_{2}^{′} .$$

As shown by way of example in FIG. 6a, the pulse sequence 111 has a first pulse break 113-1 between the first light pulse 111-1 and the second light pulse 111-2, and a second pulse break 113-2 between the second light pulse 111-2 and the third light pulse 111-3. FIG. 6a also shows, by way of example, that the pulse sequence 111 has a third pulse break 113-3 between the third light pulse 111-3 and the fourth light pulse 111-4, a fourth pulse break 113-4 between the fourth light pulse 111-4 and the fifth light pulse 111-5, a fifth pulse break 113-5 between the fifth light pulse 111-5 and the sixth light pulse 111-6, and a sixth pulse break 113-6 after the sixth light pulse 111-6.

FIG. 6a furthermore shows, by way of example, that the pulse sequence 111 has at least one further first pulse break 113-1a between the further first light pulse 111-1a and the further second light pulse 111-2a, and a further second pulse break 113-2a after the further second light pulse 111-2a.

The first to sixth pulse breaks 113-1 to 113-6 have a first to sixth duration &1 to E6 (cf. FIG. 6a). Furthermore, the further first and second pulse breaks 113-1a, 113-2a have a further first and second duration

$${ε}_{1}^{′} , {ε}_{2}^{′}$$

(cf. FIG. 6a). As shown in FIG. 6a, the pulse sequence 111 has a first portion B1 and at least one second portion B2. The first portion B1 has a duration Γ₁ (cf. FIG. 6a). The second portion B2 has a duration Γ₂ (cf. FIG. 6a).

In the first pulse schema according to FIG. 6a, the example pulse sequence 111 is shown in the uppermost row. The rows below the uppermost rows show the first to sixth light pulses 111-1 to 111-6 having the first to sixth pulse durations τ₁ to τ₆, and the further first and second light pulses 111-1a, 111-2a having the further first and second pulse durations

$${τ}_{1}^{′} , {τ}_{2}^{′}$$

(cf. reference numerals 12.1 to 12.6). The example pulse sequence 111 is formed by the individual light pulses (i.e., the first to sixth light pulses 111-1 to 111-6 and the further first and second light pulses 111-1a, 111-2a). The individual light pulses are in turn generated by the first to sixth light sources 12.1 to 12.6.

In the first pulse schema according to FIG. 6a, example interference 200 is also shown in the lowermost row. The example interference 200 has first to twelfth portions 200-1 to 200-12 and further first to fourth portions 200-1a to 200-4a. As shown in FIG. 6a, the example interference 200 has a sinusoidal curve.

In each of the individual rows of the first pulse schema according to FIG. 6a, time (in a.u.) is plotted on the X axis and amplitude (in a.u.) on the Y axis.

With reference to FIG. 6a, the sensor arrangement is configured to set each of the first to sixth pulse durations τ₁ to τ₆ at random but without the distribution (i.e., the order of the first to sixth light pulses 111-1 to 111-6) being selected at random.

As shown in FIG. 6a, the distribution includes an order, the order being defined by the first light pulse 111-1 as a starting pulse, by the second light pulse 111-2 which follows the first light pulse 111-1, and by the third light pulse 111-3 which follows the second light pulse 111-2. Furthermore, FIG. 6a shows that the fourth to sixth light pulses 111-4 to 111-6 are each successive light pulses that follow the third light pulse 111-3.

FIG. 6b shows a first example detection schema relating to the first pulse schema. In each of the individual rows of the first detection schema according to FIG. 6b, time (in a.u.) is plotted on the X axis and amplitude (in a.u.) on the Y axis. FIG. 6b shows a first and a second portion 11, 12 of the first detection schema. The first portion I1 in FIG. 6b corresponds to the first portion B1 having the duration Γ₁ in FIG. 6a. The second portion 12 in FIG. 6b corresponds to the second portion B2 having the duration Γ₂ in FIG. 6a.

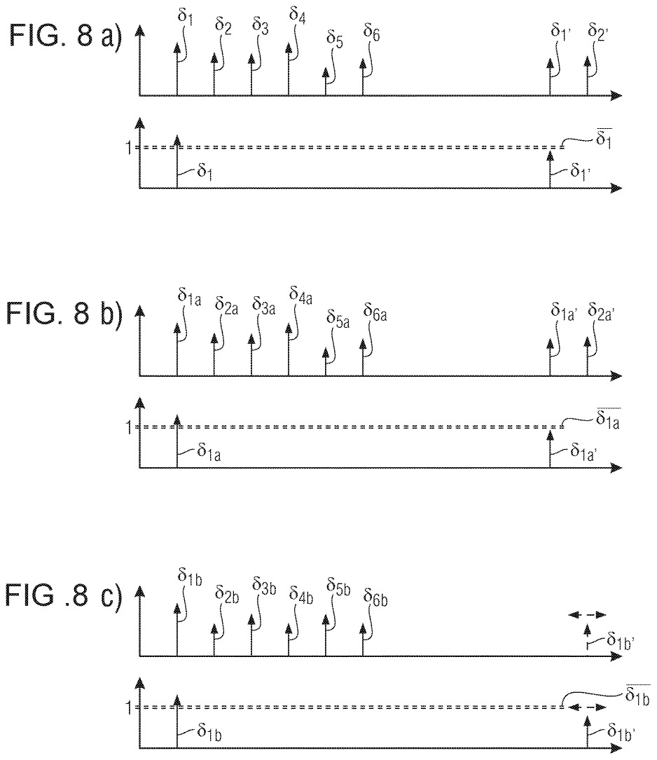

In the rows of the first detection schema according to FIG. 6b, first to twelfth signal amplitudes S1 to S12 and further first to fourth signal amplitudes S1′ to S4′ are shown (cf. reference numerals 102-2 to 102-4). Using the individual signal amplitudes (i.e., the first to twelfth signal amplitudes S1 to S12 and the further first to fourth signal amplitudes S1′ to S4′), a plurality of signal amplitudes are created for evaluation according to a first example evaluation schema (cf. FIG. 8a). The individual signal amplitudes are in turn received by the first and the second transceiver unit 102-2, 102-3 and the receiving unit 102-4.

With reference to FIGS. 6a and 6b, the sensor arrangement is configured such that the first signal amplitude S1 is acquired by temporal averaging of a first summation signal C1 over a first time period Δt₁ corresponding to the first pulse duration τ₁, the first summation signal C1 being based on the first light pulse 111-1 and the first portion 200-1 of the interference 200 (e.g., summation or superposition). Furthermore, the sensor arrangement is configured such that the second signal amplitude S2 is acquired by temporal averaging of the second portion 200-2 of the interference 200 over a second time period Δt₂ corresponding to the first pulse break 113-1. Furthermore, the sensor arrangement is configured such that the third signal amplitude S3 is acquired by temporal averaging of a second summation signal C2 over a third time period Δt₃ corresponding to the second pulse duration τ₂, the second summation signal C2 being based on the second light pulse 111-2 and the third portion 200-3 of the interference 200 (e.g., summation or superposition). In addition, the sensor arrangement is configured such that the fourth signal amplitude S4 is acquired by temporal averaging of the fourth portion 200-4 of the interference 200 over a fourth time period Δt₄ corresponding to the second pulse break 113-2.

With reference again to FIGS. 6a and 6b, the fifth to eighth signal amplitudes S5 to S8 and the ninth to twelfth signal amplitudes S9 to S12 are acquired in a similar way.

With reference to FIG. 8a, the sensor arrangement is configured such that a first corrected signal amplitude δ1 is determined on the basis of the first signal amplitude S1 and the second signal amplitude S2 (e.g., by subtraction δ1=S1-S2). Furthermore, the sensor arrangement is configured such that a second corrected signal amplitude δ2 is determined on the basis of the third signal amplitude S3 and the fourth signal amplitude S4 (e.g., by subtraction δ2=S3-S4).

With reference again to FIG. 8a, third to sixth corrected signal amplitudes δ3 to δ6 are determined in a similar way (e.g., by subtraction δ3=S5-S6; δ4=S7-S8; δ5=S9-S10; δ6=S11-S12).

With reference to FIGS. 6a and 6b, the sensor arrangement is configured such that the further first signal amplitude S1′ is acquired by temporal averaging of a further first summation signal C1′ over a further first time period

$$Δ {t}_{1}^{′}$$

corresponding to the further first pulse duration

$${τ}_{1}^{′} ,$$

the further first summation signal C1′ being based on the further first light pulse 111-1a and the further first portion 200-1a of the interference 200 (e.g., summation or superposition). Furthermore, the sensor arrangement is configured such that the further second signal amplitude S2′ is acquired by temporal averaging of the further second portion 200-2a of the interference 200 over a further second time period

$$Δ {t}_{2}^{′}$$

corresponding to the further first pulse break 113-1a. Furthermore, the sensor arrangement is configured such that the further third signal amplitude S3′ is acquired by temporal averaging of a further second summation signal C2′ over a further third time period

$$Δ {t}_{3}^{′}$$

corresponding to the further second pulse duration

$${τ}_{2}^{′} ,$$

the further second summation signal C2′ being based on the further second light pulse 111-2a and the further third portion 200-3a of the interference 200 (e.g., summation or superposition). In addition, the sensor arrangement is configured such that the further fourth signal amplitude S4′ is acquired by temporal averaging of the further fourth portion 200-4a of the interference 200 over a further fourth time period

$$Δ {t}_{4}^{′}$$

corresponding to the further second pulse break 113-2a.

With reference to FIG. 8a, the sensor arrangement is configured such that a further first corrected signal amplitude δ1′ is determined on the basis of the further first signal amplitude S1′ and the further second signal amplitude S2′ (e.g., by subtraction δ1′=S1′-S2′). Furthermore, the sensor arrangement is configured such that a further second corrected signal amplitude δ2′ is determined on the basis of the further third signal amplitude S3′ and the further fourth signal amplitude S4′ (e.g., by subtraction δ2′=S3′-S4′).

In the first evaluation schema according to FIG. 8a, an averaged signal amplitude δ̅1̅ is determined on the basis of at least the first signal amplitude S1 and the further first signal amplitude S1′ (e.g., by averaging at least the first corrected signal amplitude δ1 and the further first corrected signal amplitude δ1′). This is shown by way of example on the basis of FIG. 8a.

Further first corrected signal amplitudes in further (successive) portions B3, B4, etc. of the first detection schema can also be used for the aforementioned example averaging.

In the first evaluation schema according to FIG. 8a, further averaged signal amplitudes δ̅2̅ to δ̅6̅ can also be determined in a similar way.

Using the sensor arrangement, the output signal Sla (cf. FIG. 3) can be determined on the basis of the averaged signal amplitudes δ̅1̅ and δ̅2̅. Furthermore, using the sensor arrangement, the output signal S2a (cf. FIG. 3) can be determined on the basis of the averaged signal amplitudes δ̅3̅ and δ̅4̅. In addition, using the sensor arrangement, the output signal S3a (cf. FIG. 3) can be determined on the basis of the averaged signal amplitudes δ̅5̅ and δ̅6̅.

FIG. 6c shows a second example detection schema relating to the first pulse schema. In each of the individual rows of the second detection schema according to FIG. 6c, time (in a.u.) is plotted on the X axis and amplitude (in a.u.) on the Y axis.

In the rows of the second detection schema according to FIG. 6c, first to twelfth signal amplitudes S1 to S12 and further first to fourth signal amplitudes S1′ to S4′ are shown (cf. reference numerals 102-2 to 102-4). Using the individual signal amplitudes (i.e., the first to twelfth signal amplitudes S1 to S12 and the further first to fourth signal amplitudes S1′ to S4′), a plurality of signal amplitudes are created for evaluation according to a second example evaluation schema (cf. FIG. 8b). The individual signal amplitudes are in turn received by the first and the second transceiver unit 102-2, 102-3 and the receiving unit 102-4.

The second detection schema according to FIG. 6c differs from the first detection schema according to FIG. 6b in that the second, fourth, etc. to twelfth signal amplitudes S2, S4, S6, S8, S10, S12 are each received in all the rows (cf. reference numerals 102-2 to 102-4). The second, fourth, etc. to twelfth signal amplitudes S2, S4, S6, S8, S10, S12 correspond to the signal amplitudes acquired by temporal averaging of the second, fourth, etc. to twelfth portions 200-2, 200-4, 200-6, 200-8, 200-10, 200-12 of the interference 200 over a second, fourth, etc. to twelfth time period Δt₂, Δt₄, Δt₆, Δt₈, Δt₁₀, Δt₁₂ corresponding to the first to sixth pulse breaks 113-1 to 113-6.

The second evaluation schema according to FIG. 8b differs from the first evaluation schema according to FIG. 8a in that each corrected signal amplitude δ1a to δ6a and each further corrected signal amplitude δ1a′, δ2a′ is determined on the basis of the relevant signal amplitude (i.e., the first to eleventh signal amplitudes S1, S3, S5, S7, S9, S11) and an average of the second to twelfth signal amplitudes (and further signal amplitudes) S2, S4, S6, S8, S10, S12 and S2′, S4′, etc. This is done, for example, by subtraction δ1a=S1-MW1; δ2a=S3-MW1; δ3a=S5-MW2; δ4a=S7-MW2; δ5a=S9-MW3; δ6a=S11-MW3 and δ1a′=S1′-MW1′; δ2a′=S3′-MW1′, where MW1 is the average of S2, S4, S6, S8, S10, S12 (top row; reference numeral 102-2), MW2 is the average of S2, S4, S6, S8, S10, S12 (middle row; reference numeral 102-3), MW3 is the average of S2, S4, S6, S8, S10, S12 (bottom row; reference numeral 102-4), and MW1′ is the average of S2′, S4′, etc. (top row; reference numeral 102-2).

In the second evaluation schema according to FIG. 8b, an averaged signal amplitude δ̅1̅a̅ is determined on the basis of at least the first signal amplitude S1 and the further first signal amplitude S1′ (e.g., by averaging at least the first corrected signal amplitude δ1a and the further first corrected signal amplitude δ1a′). This is shown by way of example on the basis of FIG. 8b.

In the second evaluation schema according to FIG. 8b, further averaged signal amplitudes δ̅2̅a̅ to δ̅6̅a̅ can also be determined in a similar way.

Using the sensor arrangement, the output signal Sla (cf. FIG. 3) can be determined on the basis of the averaged signal amplitudes δ̅1̅a̅ and δ̅2̅a̅. Furthermore, using the sensor arrangement, the output signal S2a (cf. FIG. 3) can be determined on the basis of the averaged signal amplitudes δ̅3̅a̅ and δ̅4̅a̅. In addition, using the sensor arrangement, the output signal S3a (cf. FIG. 3) can be determined on the basis of the averaged signal amplitudes δ̅5̅a̅ and δ̅6̅a̅.

FIG. 7a shows a second example pulse schema having an (alternative) example pulse sequence 111. The alternative pulse sequence 111 comprises a first group 115-1 of light pulses. The first group 115-1 of light pulses comprises the first to sixth light pulses 111-1 to 111-6 (pulse durations τ₁ to τ₆).

As shown by way of example in FIG. 7a, the alternative pulse sequence 111 has a pulse break 113 after the second light pulse 111-2. The pulse break 113 has a duration ε (cf. FIG. 7a). As shown in FIG. 7a, the alternative pulse sequence 111 has a first portion B1 and at least one second portion B2 (further light pulses of the second portion B2 not being shown). The first portion B1 has a duration δ₁ (cf. FIG. 7a). The second portion B2 has a duration Γ₂ (cf. FIG. 7a).

In the second pulse schema according to FIG. 7a, the (alternative) example pulse sequence 111 is shown in the uppermost row. The rows below the uppermost row show the first to sixth light pulses 111-1 to 111-6 having the first to sixth pulse durations τ₁ to τ₆ (cf. reference numerals 12.1 to 12.6). The alternative example pulse sequence 111 is formed by the individual light pulses (i.e., the first to sixth light pulses 111-1 to 111-6). The individual light pulses are in turn generated by the first to sixth light sources 12.1 to 12.6.

In the second pulse schema according to FIG. 7a, example interference 200 is also shown in the lowermost row. The example interference 200 has first to sixth portions 200-1 to 200-6 and a subsequent portion 202. The subsequent portion 202 extends from the end of the sixth portion 200-6 to the end of the first portion B1. As shown in FIG. 7a, the example interference 200 has a sinusoidal curve.

In each of the individual rows of the second pulse schema according to FIG. 7a, time (in a.u.) is plotted on the X axis and amplitude (in a.u.) on the Y axis.

With reference to FIG. 7a, the sensor arrangement is configured to set each of the first to sixth pulse durations τ₁ to τ₆ at random and to select the distribution (i.e., the order of the first to sixth light pulses 111-1 to 111-6) at random.

As shown in FIG. 7a, the distribution includes an order, the order being defined by a permutation of the generation of the first to sixth light pulses 111-1 to 111-6 (e.g., the first light pulse 111-1 having the first pulse duration τ₁, the sixth light pulse 111-6 having the sixth pulse duration τ₆, the fifth light pulse 111-5 having the fifth pulse duration τ₅, the fourth light pulse 111-4 having the fourth pulse duration τ₄, the third light pulse 111-3 having the third pulse duration τ₃, the second light pulse 111-2 having the second pulse duration τ₂; from left to right).

All other permutations can also be provided instead of the example permutation shown in FIG. 7a.

FIG. 7b shows a third example detection schema relating to the second pulse schema. In each of the individual rows of the third detection schema according to FIG. 7b, time (in a.u.) is plotted on the X axis and amplitude (in a.u.) on the Y axis.

In the rows of the third detection schema according to FIG. 7b, first to seventh signal amplitudes S1 to S7 are shown (cf. reference numerals 102-2 to 102-4). Using the individual signal amplitudes (i.e., the first to seventh signal amplitudes S1 to S7), a plurality of signal amplitudes are created for evaluation according to a third example evaluation schema (cf. FIG. 8c). The individual signal amplitudes are in turn received by the first and the second transceiver unit 102-2, 102-3 and the receiving unit 102-4.

With reference to FIGS. 7a and 7b, the sensor arrangement is configured such that the first signal amplitude S1 is acquired by temporal averaging of a first summation signal C1 over a first time period Δt₁ corresponding to the first pulse duration τ₁, the first summation signal C1 being based on the first light pulse 111-1 and the first portion 200-1 of the interference 200. Furthermore, the sensor arrangement is configured such that the second signal amplitude S2 is acquired by temporal averaging of a second summation signal C2 over a second time period Δt₂ corresponding to the sixth pulse duration τ₆, the second summation signal C2 being based on the sixth light pulse 111-6 and the second portion 200-2 of the interference 200. Furthermore, the sensor arrangement is configured such that the third signal amplitude S3 is acquired by temporal averaging of a third summation signal C3 over a third time period Δt₃ corresponding to the fifth pulse duration τ₅, the third summation signal C3 being based on the fifth light pulse 111-5 and the third portion 200-3 of the interference 200. Furthermore, the sensor arrangement is configured such that the fourth signal amplitude S4 is acquired by temporal averaging of a fourth summation signal C4 over a fourth time period Δt₄ corresponding to the fourth pulse duration τ₄, the fourth summation signal C4 being based on the fourth light pulse 111-4 and the fourth portion 200-4 of the interference 200. Furthermore, the sensor arrangement is configured such that the fifth signal amplitude S5 is acquired by temporal averaging of a fifth summation signal C5 over a fifth time period Δt₅ corresponding to the third pulse duration τ₃, the fifth summation signal C5 being based on the third light pulse 111-3 and the fifth portion 200-5 of the interference 200. Furthermore, the sensor arrangement is configured such that the sixth signal amplitude S6 is acquired by temporal averaging of a sixth summation signal C6 over a sixth time period Δt₆ corresponding to the second pulse duration τ₂, the sixth summation signal C6 being based on the second light pulse 111-2 and the sixth portion 200-6 of the interference 200. In addition, the sensor arrangement is configured such that the seventh signal amplitude S7 is acquired (in all rows) by temporal averaging of the subsequent portion 202 of the interference 200 over a seventh time period Δt₇ corresponding to the pulse break 113.

With reference to FIG. 8c, the sensor arrangement is configured such that each corrected signal amplitude (i.e., the first to sixth corrected signal amplitudes δ1b to δ6b) is determined on the basis of the relevant signal amplitude (i.e., the first to sixth signal amplitudes S1 to S6) and the seventh signal amplitude S7 (e.g., by subtraction δ1b=S1-S7; δ2b=S2-S7; δ3b=S3-S7; δ4b=S4-S7; δ5b=S5-S7; δ6b=S6-S7). By way of example, FIG. 8c shows a further first corrected signal amplitude δ1b′ which can be determined in a similar way for a further first light pulse of the second portion B2.

In the third evaluation schema according to FIG. 8c, an averaged signal amplitude δ̅1̅b̅ is determined by, for example, averaging at least the first corrected signal amplitude δ̅1̅b̅ and the further first corrected signal amplitude δ1b′. This is shown by way of example on the basis of FIG. 8c.

In the third evaluation schema according to FIG. 8c, further averaged signal amplitudes δ̅2̅b̅ to δ̅6̅b̅ can also be determined in a similar way.

Using the sensor arrangement, the output signal Sla (cf. FIG. 3) can be determined on the basis of the averaged signal amplitudes δ̅1̅b̅ and δ̅6̅b̅. Furthermore, using the sensor arrangement, the output signal S2a (cf. FIG. 3) can be determined on the basis of the averaged signal amplitudes δ̅4̅b̅ and δ̅5̅b̅. In addition, using the sensor arrangement, the output signal S3a (cf. FIG. 3) can be determined on the basis of the averaged signal amplitudes δ̅2̅b̅ and δ̅3̅b̅.

As shown by way of example in FIGS. 8a to 8c, the averaged signal amplitude (i.e., the averaged signal amplitude δ̅1̅, δ̅1̅a̅, δ̅1̅b̅) only minimally differs from an example reference value 1. The example reference value 1 is produced in a reference pulse schema in which the pulse sequence comprises light pulses each having an amplitude of 1 and in which there is no interference. In addition, the light pulses are generated or modulated at a fixed frequency in the reference pulse schema.

If interference is present in such a reference pulse schema, however, there will be a significant (systematic) deviation from the example reference value 1 (systematic measurement error).

On the basis of FIGS. 8a to 8c, it will now be explained how a systematic measurement error of this kind can be substantially prevented or minimized in the first to third evaluation schemas. The averaged signal amplitude (i.e., the averaged signal amplitude δ̅1̅, δ̅1̅a̅, δ̅1̅b̅) is substantially at or close to the example reference value 1.

For example, the interference 200 (cf. FIGS. 6a and 7a) is interference caused by environmental influences (e.g., ambient light, light from other measurement systems, electrical interference from a generator, etc.).

In the above explanations, the first to sixth light pulses 111-1 to 111-6 having the first to sixth pulse durations τ₁ to τ₆ have been explained by way of example. It goes without saying that embodiments of the present disclosure similarly allow for said suppression of interference on the basis of at least the first to third light pulses 111-1 to 111-3 having the first to third pulse durations τ₁ to τ₃.

An intermediate metrology block (cf. FIG. 3; unit 102-2, 102-3) preferably comprises a single receiving unit (e.g., unit 20a, 20b) and a single transmission unit (e.g., unit 10a, 10b). Alternatively, an intermediate metrology block can also comprise two receiving units and/or two transmission units. A start or an end of the metrology chain is preferably formed by a single transmission unit (e.g., unit 102-1) or a single receiving unit (e.g., unit 102-4).

Within the metrology chain, light is transmitted in each case between individual transmission units and individual receiving units; a direction of transmission can be that shown in FIG. 3 (e.g., arrows 103-1 to 103-3) or the opposite direction.

In the latter case, the first position P1 in FIG. 2 can alternatively correspond to a position at or close to the blade tip of the rotor blade 1. In turn, the second and third positions P2, P3 in FIG. 2 correspond to (inverse) positions within the rotor blade 1. The fourth position P4 in FIG. 2 can alternatively correspond to a position at or close to the blade root of the rotor blade 1. In other words, the arrangement/order within the metrology chain can advantageously be the following: transmission unit in the blade tip, receiving unit in the blade root, transceiver units in between.

Advantageously, the individual light pulses are generated/detected within the metrology chain such that, for example, the individual transmission units (or light sources) only ever generate one light pulse (e.g., the first/second pulse schema; cf. reference numerals 12.1 to 12.6), and the corresponding receiving units each acquire the corresponding signal (e.g., the first to third detection schemas; cf. reference numerals 102-2 to 102-4).

Embodiments of the present disclosure have the following advantages in particular. Setting the pulse durations (or durations of pulse breaks) at random and/or selecting the distribution of the light pulses within the pulse sequence at random (e.g., by permutation or by deviating from a sequential order) can generate jitter, thereby in turn allowing for efficient interference suppression. This leads substantially to an advantageous error transfer function. Combining the random setting of the pulse durations and the random selection of the distribution can also result in a greater variation of the jitter. This again leads to an optimized error transfer function.

Preferably, the burst duration is variable over a plurality of portions of the pulse sequence (bursts). Alternatively, the burst duration can also be constant over a plurality of portions of the pulse sequence. In the latter case, however, the pulse durations (or durations of pulse breaks) are likewise variable, as in the former case.

Other types of polarization can also be implemented instead of linearly polarized light.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A sensor arrangement for recording at least a first deformation of a rotor blade of a wind turbine, comprising:
a transmission unit arranged at a first position; and
at least one first transceiver unit arranged along a bending line of the rotor blade at a second position,
wherein the sensor arrangement is configured to generate a first light, a second light, and a third light,
wherein the transmission unit is configured such that the first light is generated as a first light pulse having a first pulse duration,
wherein the sensor arrangement is configured such that the second light is generated as a second light pulse having a second pulse duration,
wherein the at least one first transceiver unit is configured such that the third light is generated as a third light pulse having a third pulse duration,
wherein the sensor arrangement is configured such that the first light pulse, the second light pulse, and the third light pulse are generated as part of a pulse sequence, wherein the first light pulse, the second light pulse, and the third light pulse have a distribution within the pulse sequence,
wherein the sensor arrangement is configured to set the first pulse duration, the second pulse duration, and the third pulse duration at random and/or to select the distribution at random.

2. The sensor arrangement according to claim 1, wherein the transmission unit is configured to generate the first light, and wherein the first transceiver unit is configured to generate the second and the third light.

3. The sensor arrangement according to claim 1, wherein the transmission unit is configured to generate the first and the second light, and wherein the first transceiver unit is configured to generate the third light.

4. The sensor arrangement according to claim 1, wherein the sensor arrangement is configured to set each of the first pulse duration, the second pulse duration, and the third pulse duration at random, and wherein the distribution is not selected at random.

5. The sensor arrangement according to claim 4, wherein the distribution includes an order, wherein the order is defined by:
the first light pulse as a starting pulse,
the second light pulse, which follows the first light pulse, and
the third light pulse which follows the second light pulse.

6. The sensor arrangement according to claim 4, wherein the sensor arrangement is configured such that the first light pulse, the second light pulse, and the third light pulse are generated such that the pulse sequence has a first pulse break between the first light pulse and the second light pulse, and a second pulse break between the second light pulse and the third light pulse.

7. The sensor arrangement according to claim 6, wherein the sensor arrangement is configured such that:
a first signal amplitude is acquired by temporal averaging of a first summation signal over a first time period corresponding to the first pulse duration, wherein the first summation signal is based on the first light pulse and a first portion of an interference,
a second signal amplitude is acquired by temporal averaging of a second portion of the interference over a second time period corresponding to the first pulse break,
a third signal amplitude is acquired by temporal averaging of a second summation signal over a third time period corresponding to the second pulse duration, wherein the second summation signal is based on the second light pulse and a third portion of the interference,
a fourth signal amplitude is acquired by temporal averaging of a fourth portion of the interference over a fourth time period corresponding to the second pulse break,
a first corrected signal amplitude is determined based on the first signal amplitude and at least the second signal amplitude, and
a second corrected signal amplitude is determined based on the third signal amplitude and at least the fourth signal amplitude.

8. The sensor arrangement according to claim 1, wherein the sensor arrangement is configured to set each of the first pulse duration, the second pulse duration, and the third pulse duration at random and to select the distribution at random.

9. The sensor arrangement according to claim 8, wherein the distribution includes an order, wherein the order is defined by a permutation of the generation of the first light pulse, the second light pulse, and the third light pulse.

10. The sensor arrangement according to claim 1, wherein the sensor arrangement is configured such that the first light pulse, the second light pulse, and the third light pulse are generated as part of a first group of light pulses, wherein the pulse sequence includes the first group of light pulses, wherein the sensor arrangement is configured to set all pulse durations of the first group of light pulses and all durations of pulse breaks within a first portion of the pulse sequence at random in each case such as to obtain a randomly set total duration made up of the pulse durations of the first group of light pulses and the durations of the pulse breaks.

11. The sensor arrangement according to claim 10, wherein a duration of the first portion of the pulse sequence is defined by the total duration made up of the pulse durations of the first group of light pulses and the durations of the pulse breaks.

12. The sensor arrangement according to claim 10, wherein a duration of the first portion of the pulse sequence is fixedly predetermined by the sensor arrangement, wherein the sensor arrangement is configured to adapt either a pulse duration of a final light pulse of the first group of light pulses or a duration of a final pulse break within the first portion of the pulse sequence such that the total duration made up of the pulse durations of the first group of light pulses and the durations of the pulse breaks is equal to the duration of the fixedly predetermined first portion of the pulse sequence.

13. The sensor arrangement according to claim 10, wherein the sensor arrangement is configured such that at least one further first light pulse associated with the first light pulse is generated as part of at least one second group of light pulses, wherein the pulse sequence includes the second group of light pulses, wherein the first group of light pulses and the second group of light pulses are successive groups of light pulses, wherein the sensor arrangement is configured to generate the further first light pulse with a further first pulse duration.

14. The sensor arrangement according to claim 13, wherein the sensor arrangement is configured such that:
a first signal amplitude is acquired by temporal averaging of a first summation signal over a first time period corresponding to the first pulse duration, wherein the first summation signal is based on the first light pulse and a first portion of an interference,
a further first signal amplitude is acquired by temporal averaging of a further first summation signal over a further first time period corresponding to the further first pulse duration, wherein the further first summation signal is based on the further first light pulse and a further first portion of the interference, and
an averaged signal amplitude is determined based on at least the first signal amplitude and the further first signal amplitude.

15. The sensor arrangement according to claim 1, wherein the sensor arrangement is configured to record at least a first torsion of the rotor blade based on a polarization rotation of the first light.
